(19) United States
(12) Patent Application Publication
(10) Pub. No.: US 2009/0184981 A1
(43) Pub. Date: Jul. 23, 2009

(54) SYSTEM, METHOD AND COMPUTER PROGRAM PRODUCT FOR DISPLAYING IMAGES ACCORDING TO USER POSITION

(76) Inventor: Lucio D'Orazio Pedro de Matos, Antelope, CA (US)

Correspondence Address: Lucio D'Orazio Pedro de Matos, 5244 Elgin Hills way, Antelope, CA, 95843, US

(21) Appl. No.: 12/357,373

(22) Filed: Jan. 21, 2009

Related U.S. Application Data
(60) Provisional application No. 61/022,828, filed on Jan. 23, 2008.

(51) Int. Cl. G09G 5/00; H04N 5/228

(52) U.S. Cl. 345/676; 348/169

(57) ABSTRACT

A method is described for displaying images according to user position includes the steps of receiving a plurality of source images, indexing the plurality of source images and capturing a current user's position relative to a display suitable for presenting the plurality of source images. The method further includes choosing a one of the plurality of source images by relating at least one parameter of the current user's position with indices of the indexed plurality of source images and displaying the one of the plurality of source images on the display.

### CROSS-REFERENCE TO RELATED APPLICATIONS

The present Utility patent application claims priority benefit of the U.S. provisional application for patent Ser. No. 61/022,828 filed on 23 Jan. 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to software. More particularly, the invention relates to a method for displaying digital images based on user motion.

### BACKGROUND OF THE INVENTION

The indexing of data including images has been in use for decades. Many data structures for storing data such as, but not limited to, arrays or lists are considered these days as native features to many programming languages. What has not been used is recalling indexed data (i.e., images) based on user location. There are also many known methods for controlling, browsing and manipulating images by using an input device such as a mouse or joystick. However, these methods all require the use of the input devices. There are also current solutions for capturing an end-user position (i.e., viewing angle) to automatically generate (i.e., render) or manipulate (i.e., alter) an image. However, these solutions are only generating or manipulating images based on user location and do not have the ability to index a collection of existing images and automatically choose an image to be displayed based on the current location of the user.

Processes for obtaining user location are known in the prior art. The following are existing solutions related to capturing the user location (i.e., head location) for some purpose. However, none of these solutions captures user location for the purpose of choosing indexed images. One such solution is a method of and system for determining the angular orientation of an object. Another such solution involves altering a display on a viewing device based upon a user proximity to the viewing device. Another location capturing solution is a real-time computer vision system that tracks the head of a computer user to implement real-time control of games or other applications. Yet other solutions involve motion-based command generation technology and methods and systems for enabling direction detection when interfacing with a computer program.

In view of the foregoing, there is a need for improved techniques for indexing existing images and automatically choosing an image to be displayed based on the current location.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for displaying digital images from an image source on a display screen based on the current position and movements of a user, in accordance with an embodiment of the present invention;

FIG. 2 is a flowchart illustrating an exemplary method performed by an image display system based on the position of a user, in accordance with an embodiment of the present invention;

FIGS. 3A, 3B and 3C illustrate exemplary images being displayed by a website that displays images based the location of a user, in accordance with an embodiment of the present invention;

FIGS. 4A, 4B and 4C illustrate exemplary images, which are based on an original image that is altered, being displayed on an exemplary display system based on the location of a user, in accordance with an embodiment of the present invention;

FIG. 5 is a flowchart illustrating an exemplary method for displaying an image based on the position of a user in which the images are derivations of a single image, in accordance with an embodiment of the present invention;

FIG. 6 is a flowchart illustrating an exemplary process for using a method of displaying images based on the location of a user to play videos based on user motion, in accordance with an embodiment of the present invention;

FIG. 7 is a flowchart illustrating an exemplary process for using a method of displaying images based on the location of a user to display a 3D television broadcast, in accordance with an embodiment of the present invention;

FIG. 8 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and computer program product for displaying images according to user position is presented.

In one embodiment, a method for displaying images according to user position is presented. The method includes the steps of receiving a plurality of source images, indexing the plurality of source images and capturing a current user's position relative to a display suitable for presenting the plurality of source images. The method further includes choosing a one of the plurality of source images by relating at least one parameter of the current user's position with indices of the indexed plurality of source images and displaying the one of the plurality of source images on the display. Another embodiment further includes the step of repeating the steps of capturing, choosing and displaying until the method is terminated. Yet another embodiment further includes the step of repeating, until the method is terminated, the step of capturing and repeating the steps of choosing and displaying if the current user's position is different from a previous captured user's position. Still another embodiment further includes the step of repeating the steps of capturing, choosing and displaying upon command from the user. In another embodiment the plurality of source images includes a plurality of digital still images. In yet another embodiment the plurality of source images includes at least one still image and a plurality of still images derived from altering the at least one still image. In other embodiments the plurality of source images includes a plurality of motion videos and the method further includes the step of starting playback of the plurality of source images at substantially the same time and the plurality of motion videos includes a plurality of digital video and is received from a remote computer. In still another embodiment the plurality of source images includes a plurality of motion videos being received on a plurality of television channels. Yet another embodiment further includes the steps of prompting a user to assume a plurality of determined calibration positions relative to a display; capturing a position of the user at each of the plurality of determined calibration positions; and storing the captured positions for relating further captured positions to the indexed plurality of source images.

In another embodiment a method for displaying images according to user position is presented. The method includes steps for receiving a plurality of source images, steps for indexing the plurality of source images, steps for capturing a current user's position, steps for choosing a one of the plurality of source images and steps for displaying the one of the plurality of source images. Another embodiment further includes for repeating the steps for capturing, choosing and displaying. Still another embodiment further includes steps for calibrating a user's positions.

In another embodiment a computer program product for displaying images according to user position is presented. The computer program product includes computer code for receiving a plurality of source images, computer code for indexing the plurality of source images and computer code for capturing a current user's position relative to a display suitable for presenting the plurality of source images. The computer program product further includes computer code for choosing a one of the plurality of source images by relating at least one parameter of the current user's position with indices of the indexed plurality of source images, computer code for displaying the one of the plurality of source images on the display and a computer-readable medium storing the computer code. Another embodiment further includes computer code for repeating the capturing, choosing and displaying. Yet another embodiment further includes computer code repeating the capturing and repeating the choosing and displaying if the current user's position is different from a previous captured user's position. Still another embodiment further includes computer code for repeating the capturing, choosing and displaying upon command from the user. In another embodiment the plurality of source images includes a plurality of digital still images. In yet another embodiment the plurality of source images includes at least one still image and a plurality of still images derived from altering the at least one still image. In still other embodiments the plurality of source images includes a plurality of motion videos and the computer program product further includes computer code for starting playback of the plurality of source images at substantially the same time and the plurality of motion videos includes a plurality of digital video and is received from a remote computer. In yet another embodiment the plurality of source images includes a plurality of motion videos being received on a plurality of television channels. Yet another embodiment further includes computer code for prompting a user to assume a plurality of determined calibration positions relative to a display; capturing a position of the user at each of the plurality of determined calibration positions; and storing the captured positions for relating further captured positions to the indexed plurality of source images.

In another embodiment a system for displaying images according to user position is presented. The system includes means for receiving a plurality of source images, means for indexing the plurality of source images, means for capturing a current user's position, means for choosing a one of the plurality of source images and means for displaying the one of the plurality of source images. Yet another embodiment further includes means for repeating the steps for capturing, choosing and displaying. Still another embodiment further includes means for calibrating a user's positions.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

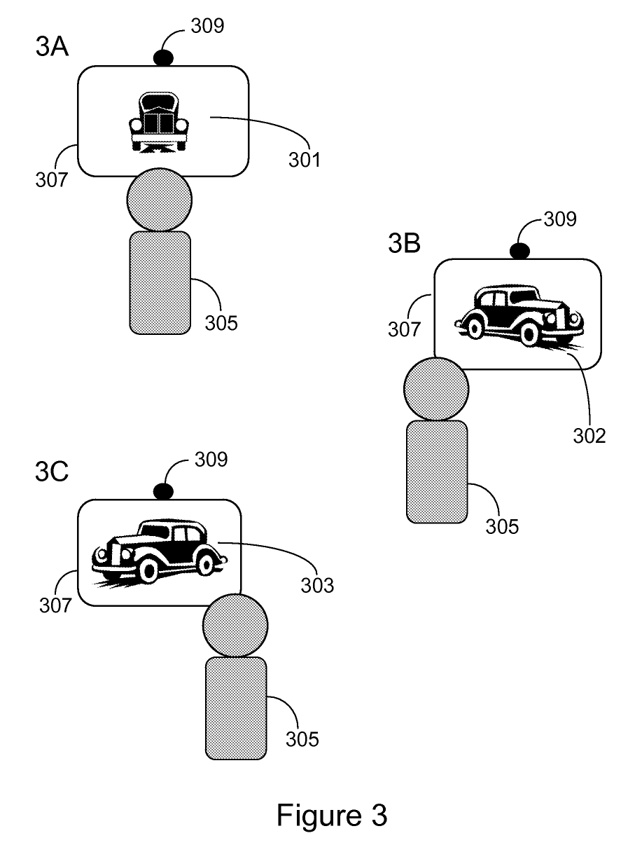

Preferred embodiments of the present invention display digital images on a screen based on the current position and movements of an unencumbered user watching the screen. For example, without limitation, a digital picture of a car may be displayed on a screen, and as a person moves around the screen, the car in the picture rotates revealing the other sides of the car and revealing what is behind the car in the picture, creating a 3D effect, as shown by way of example in FIG. 3. In another non-limiting example, a user is looking at a computer screen displaying the picture of a car. As the user moves his head to the right and to the left, the image on the computer screen reacts to the movements and rotates the car or reveals another side of the car or what is behind the car. In yet another non-limiting example a picture of a forest is displayed, and as a viewer moves his head, he see trees from different angles and what is behind them. Preferred embodiments of the present invention provide a method for storing multiple images in memory, and based on user present position with relation to the screen, one specific image is automatically chosen and displayed, producing effects by which the image displayed seems to react according to one's movements and creating a real-time effect and enhancing the viewing experience. The method according to preferred embodiments can be applied for viewing still images as well as video.

Methods according to preferred embodiments typically comprise the following elements. One element is a computer, such as, but not limited to, a PC, a laptop, a cell phone, a personal digital assistant (PDA), etc. that is operable to process digital information for executing the method. This computer comprises common technology such as, but not limited to, a processor, a memory buffer, and common multi-media capabilities. Another element is an image source from which digital images of any kind and format may be obtained. An image source may be for example, without limitation, files in a hard drive, portable digital media, or files downloaded from a remote system. These image sources may be still image files, digital video files, video channels, video streaming, etc. A receiver (i.e., tuner) of television channels, for example, without limitation, can also be an image source since it can provide images to be displayed on a screen. Another element of preferred embodiments is a display screen or display system that is operable to render and display still or animated images for example, without limitation, a projector, television, monitor, LCD display, etc. This display screen may include additional hardware such as, but not limited to, a graphics card or equivalent for sending information from the computer to the display screen. Another element of preferred embodiments is a parameter indicating the user position. There are several existing methods for capturing a user position by detecting the user with devices such as, but not limited to, a digital camera, infrared sensor, or other types of sensors. The location system comprises the hardware and capacity to employ at least one of these existing methods OR FUTURE METHODS FOR CAPTURING, ESTIMATING AND INDICATING USER POSITION THROUGH ONE OR MORE PARAMETERS. A preferred method for capturing a user location in for preferred embodiments uses a generic PC camera and an existing method for capturing the image of the user and determining the position of the user, which is prior art. However, those skilled in the art, in light of the present teachings will readily recognize that a multiplicity of possible methods for capturing a user's position may be used in preferred embodiments of the present invention. Yet another element of preferred embodiments is a computer program for buffering and displaying digital images based on the obtained parameter that indicates user current position.

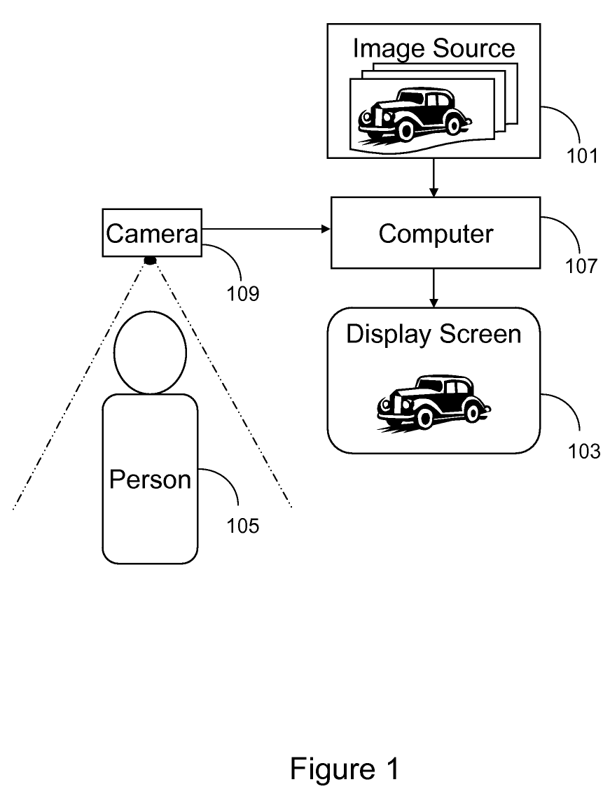

FIG. 1 illustrates an exemplary system for displaying digital images from an image source 101 on a display screen 103 based on the current position and movements of a user 105, in accordance with an embodiment of the present invention. In the present embodiment, the system comprises image source 101, display screen 103, and a computer 107 wherein a program for processing the display method has information access to image source 101, display screen 103, and access to obtain a parameter that indicates the position of user 105 employing prior art. In the present embodiment a camera 109 is used to determine the position of user 105; however, alternate embodiments may use various different means for determining the position of the user such as, but not limited to, infrared sensorS, OR HEAT CAMERAS, OR APARATUS PLACED WITH AN INCUMBERED USER, an inclinometer in the computer (being a mobile device), or other types of sensors, etc.

In the present embodiment, computer 107 has the necessary drivers, adapters and resources for interfacing with the other hardware components described above, camera 109, image source 101, and display screen 103. Furthermore, computer 107 is capable of executing the program for processing the display method. Without a program that can process a method of displaying an image based on user location according to preferred embodiments of the present invention, the system is not complete.

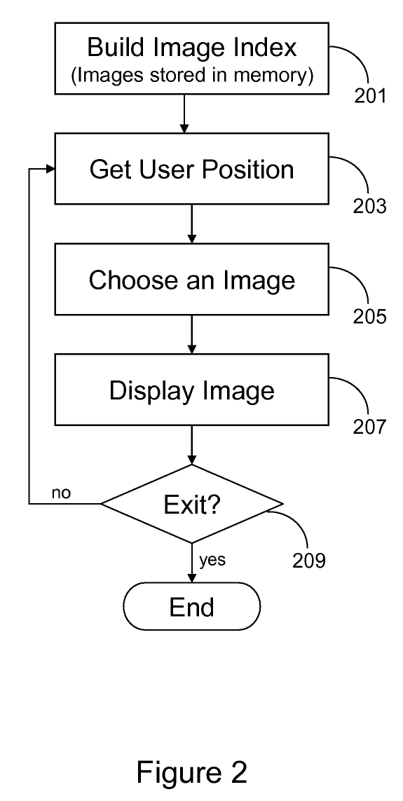

FIG. 2 is a flowchart illustrating an exemplary method performed by an image display system based on the position of a user, such as, but not limited to, the system illustrated by way of example in FIG. 1, in accordance with an embodiment of the present invention. In the present embodiment, the method starts at step 201 where a program, when executed, retrieves multiple images from an image source and stores these images in memory. Within the memory these images are indexed, each with a number or name that can be recalled to refer to a specific image. For example, without limitation, by storing images in an array OF OBJECTS or similar data structure, the numeric index of the array can be used to recall a specific image. Then the program proceeds to step 203, which begins a loop. In the loop, the program obtains the position of the viewing user in step 203, employing one of many existing methods for this. The position information obtained comprises one or more parameters that indicate the user position and/or the movements of the user. For example, without limitation, numeric parameters returned may indicate how far to the left, to the right, up, down, far, or near the user is located with relation to the display screen. In step 205 the parameter(s) returned are used to automatically choose an image from the index, and in step 207 this image is displayed on the display screen. Because the image displayed is chosen based on data generated by identifying a person's location, the person's movements have a programmatic effect on how the images from the image source are selected and displayed. In step 209 the program determines if the loop is to be exited. If so, the method ends, and if not, the program returns to step 203 to retrieve the position of the user again. The method runs in a loop in the present embodiment so the program repeatedly attempts to obtain the current position of the user and repeatedly uses the data to select and display the image on the display screen until the process is exited, killed, or aborted. The objective if the hardware capabilities allow is to have images swapped responding to user motion in real-time. The effect viewed by the user depends on the intention of the application and on what the images stored look like, meaning, the possibilities are practically unlimited. However, alternate embodiments may be implemented that do not run in a loop. These embodiments would display an image based on the location of the user at the time of execution, and this image does not change until the program is executed again, for example, without limitation, by a prompt from the user, OR REQUEST FROM OTHER PROGRAM.

When the program is executed in the present embodiment, in a loop, it obtains the user position or the viewing angle of the user, with relation to the display screen based on existing methods, and the parameter obtained may be used to run calculations, conditions and decisions to select a specific image from memory and display this image. The images the program can display are existing images that are stored in memory before the loop begins. These are not fabricated images rendered on the fly. There are existing methods for generating images based on user positioning. The present method in accordance with the present embodiment, in contrast, does not generate or manipulate images dynamically as video games do. Instead, this method allocates existing digital image files in memory early on and recalls these images to be displayed based on user position.

In the present embodiment, the user location parameter(s) may indicate in one-dimension, two-dimensions, or three-dimensions where the user is located. Preferred embodiments have no limitation to a specific dimension. For example, without limitation, one application may be designed to be concerned with only how far to the left and right the user is while disregarding vertical position and depth, and another application may also be concerned with how far up or down the user is. Yet another application may also be concerned with how far or near the user is. The dimensions to be taken into account depend on each application. The method itself is not limited, as it can work with one or multiple parameters pertaining to the user location.

In the present embodiment, the images to be included in the indexed memory to be displayed from the image source may be selected by the user with a prompt or may be defined by other means. This is determined in the application before the method begins. Whether the image is selected by the user or otherwise, the program must have information as to what images from the image source are to be processed and displayed during method execution. In common coding, the software can declare an object class for containing image files and then declare an array of image objects or other data structures as a container for a collection of image objects, such as, but not limited to, a link list, or VECTOR. Once the program has information as to which images from the image source are to be used, the program stores images into declared data structures, and the images are available in accessible memory throughout the rest of the program execution until released or overwritten. Once the program obtains parameter values about the person's location, decision conditions can be used to determine which image to display. The program quickly recalls the image from the data structure and passes it to the display screen.

Sample Code in Table 1 shows an exemplary code for a C++ program “main” from a system for displaying images depending on the location of a user, in accordance with an embodiment of the present invention. In the present embodiment, the program has an object class called IMAGE for storing bitmap image information, and the program has an array of IMAGE declared, with pre-allocated space for storing one hundred IMAGE objects. Then, the program loads one hundred pictures of a car into this array, each picture showing the car from a different angle. After the one hundred images from the image source are stored in the array of IMAGE, the program in this example may invoke a subroutine to get a numeric variable x_position about the user's current location, which is a numeric value from ZERO to NINETY NINE. With this value, the program may call a function to refresh the screen display with the IMAGEx_position], which displays the image of the car at a certain angle depending on the index provided (i.e., the user's location). Therefore, depending on the value of the user's position, a different image is displayed on the display screen, showing the car from a different angle. The program runs in a loop so that the user's movements are reflected quickly on the display screen with other images displayed.

For clever effects, the program may, for example without limitation, first alter all images by applying filters, distortion, or effects, such as, but not limited to, artifacts or changes in pixel orientation. After images “in memory” have been modified, the loop may commence, and images are automatically selected and displayed based on user location. In accordance with an embodiment of the present invention, there are no dynamic image alterations being done on the fly as the method executes in a loop. However, images appear differently because they are altered and stored before the loop executed. Prior art exists that “alters” or “manipulates” an image dynamically based on user position. However, by applying the method in accordance with the present embodiment, better performance is experienced, because there is no “alteration” or “manipulation” being done to images during execution time. In contrast to the prior art, this method can be used to have images altered or manipulated up-front then stored in memory so that when the method is executed, the method is only “selecting” an image to display.

In a non-limiting practical example of a method that alters images prior to execution of the program, the program has an image that is to be displayed. Depending on the user position, the image may have different appearances as a result of programmed digital effects. In advance, the program applies effects on the image and stores one hundred different resulting images, or in other words, the program stores one hundred altered images that are the result of applying the filter or effects with a parameter value ranging from one to one hundred. The one hundred images may differ from each other slightly or by a great deal, depending on what the effect or filter applied does. After the program has one hundred processed images in memory, the program starts the method, attempting to obtain the user's location and displaying an image according to the parameter received. There is no need to process the image again during the loop execution, thus increasing the efficiency of the program.

The following describes some non-limiting examples of applications that may employ various embodiments of the present invention. One such application is displaying still images in a website based on user motion. FIGS. 3A, 3B and 3C illustrate exemplary images 301, 302 and 303 displayed by a website that displays images based the location of a user 305, in accordance with an embodiment of the present invention. In the present embodiment, an automobile company displays an image of a car on their website. When user 305 views the car on a computer display 307, the car rotates according to the head movements of user 305 as determined by a sensor 309. A component object model application such as, but not limited to, ActiveX, Flash or Java plug-in applications may be embedded on the Internet browser window to download the image file and execute the method. Then, the downloaded images of the car may be delivered by the website as multiple image files or as a single file containing multiple images. In the present example, when user 305 is located at the center of computer display 307, image 301 is displayed, which shows the front of the car. When user 305 is located to the left of computer display 307, image 302 is displayed, which shows the left side of the car, and when user 305 is located to the right of computer display 307, image 303 is displayed, which shows the right side of the car.

In the present example, the application stores images 301, 302 and 303 in memory, for example, without limitation, in an array OF OBJECTS. The application then starts the loop portion of the program, running a function to obtain the viewing angle of user 305 based on the image captured by sensor 309. In the present example, sensor 309 is a generic USB camera; however, alternate embodiments may use various different types of location sensors such as, but not limited to, a camera built into the computer, infrared sensors, heat cameras, or apparatus placed with an encumbered user. Based on the user position, which is a parameter returned by the function, the application decides on a specific image of the car to be displayed within the application canvas embedded on the webpage. This runs in a loop until the application is terminated by the user, or killed (i.e., aborted). Please refer to sample code in Table 1 for a non-limiting example of what a program ‘main’ may look like in this case.

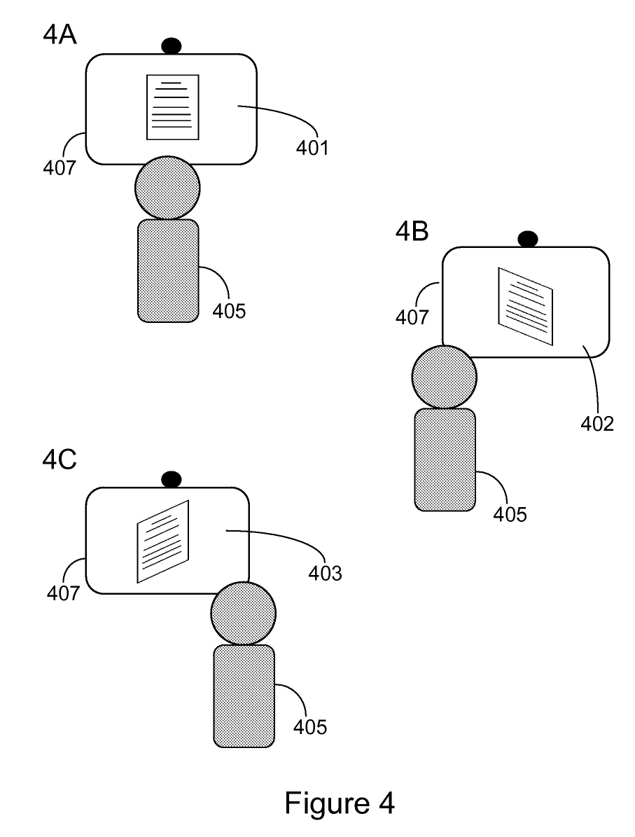

In another non-limiting example of an application that may use a preferred embodiment of the present invention, the application displays altered images based on user motion. FIGS. 4A, 4B and 4C illustrate exemplary images 401, 402 and 403, which are based on an original image that is altered, being displayed on an exemplary display system based on the location of a user 405, in accordance with an embodiment of the present invention. In the present embodiment, user 405 is viewing a document on a computer display 407 in a way that the document appears always perpendicular to the user-viewing angle, as if the document always appears flat. For example, without limitation, when user 405 moves his head to the right, as shown by way of example in FIG. 4C, image 403 is displayed where the left side of the document is stretched and the right side of the document is contracted. When user 405 moves his head to the left, as shown by way of example in FIG. 4B, image 402 is displayed where the right side of the document is stretched while the left side of the document is contracted. FIG. 4A illustrates user 405 directly in front of computer display 407 where image 401 is displayed. Image 401 shows the document in an unaltered state. The desired effect is that the document canvas generally appears to be perpendicular to the user's viewing angle.

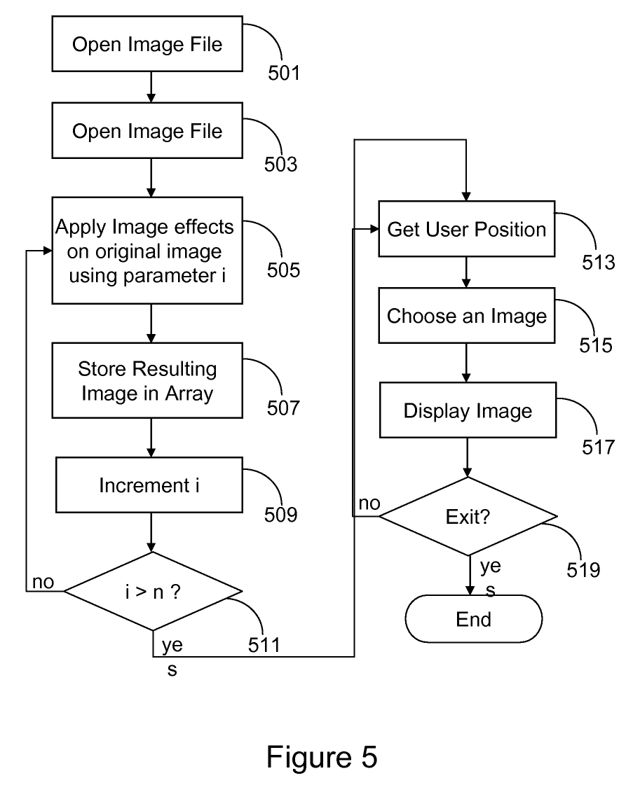

FIG. 5 is a flowchart illustrating an exemplary method for displaying an image based on the position of a user in which the images are derivations of a single image, in accordance with an embodiment of the present invention. In the present embodiment, unlike existing methods that process image effects on the fly as the user moves around, the method applies the effect on a single image using n parameter values before the display loop is executed. The method starts at step 501 where an original image file is opened. Then in step 503, an i parameter is set to a starting point, such as number zero. Step 505 begins a loop that generates n resulting images by altering the original image and stores these images in memory, indexed for recall. In step 505 image effects are applied on the original image using the i parameter. In step 507 this altered image is stored in an array OF OBJECTS, or other type of data structure, and indexed for recall. In step 509 the i parameter is incremented, and it is determined if i is greater than n in step 511. If i is less than n, the method returns to step 505, and the original image is altered again using the new i parameter. If the i parameter is greater than n, the method proceeds to step 513 where the display loop begins. In step 513 the position of the user is retrieved, and in step 515 an image to display is chosen according to this user position. The image is displayed in step 517. In step 519 it is determined if the display loop is to be exited. If so, the method ends, and if not, the method returns to step 513 to re-execute the display loop. This loop is executed repeatedly until the loop is exited. There are no image effects being processed on the fly as the user moves. Any image effects are processed prior to display, and the resulting images are buffered before the display loop begins. During the loop, when the user location is determined in step 513, the method only chooses an image to display in step 515 rather than generating an image and then displaying that image. Sample code in Table 2 shows a non-limiting example of what a “main” C++ program for this application may look like, in accordance with the present embodiment.

In another non-limiting example of an application that may use a preferred embodiment of the present invention, the application plays videos based on user motion. In this application, a user is watching a movie or other type of video on a display screen. As the user moves to the right with respect to the screen, the angle of the scene in the video rotates to the right. As the user moves to the left, the angle of the scene in the video rotates to the left. As the user centers with respect to the screen, the angle of the scene returns to the initial form.

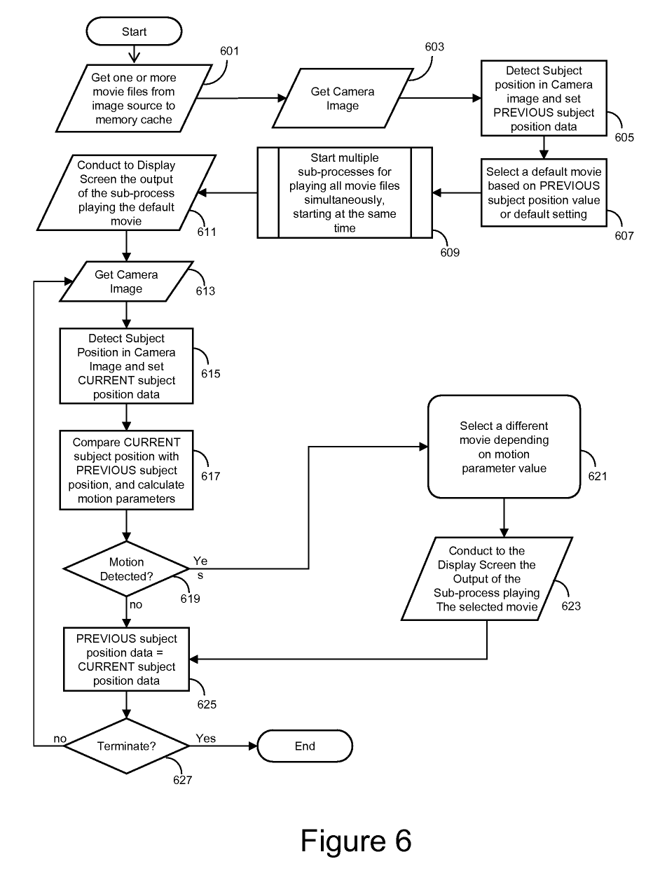

FIG. 6 is a flowchart illustrating an exemplary process for using a method of displaying images based on the location of a user to play videos based on user motion, in accordance with an embodiment of the present invention. In the present embodiment, the process begins at step 601 where one or more video files are retrieved from an image source and stored in a memory cache. For example, without limitation, the image source may be a hard drive holding multiple movie files, containing the same movie scenes with the same duration that are each recorded by a different camera from a different angle when the movie was originally recorded. In another non-limiting example, the image source may be digital video streamed from a remote computer. A camera mounted near the display screen is operable to capture the user position. The process obtains a camera image in step 603 and uses this camera image to detect the location of the user to determine which processing movie file should be conducted to the display canvas in step 605. This location is set as PREVIOUS subject position data. In step 607 this PREVIOUS subject position data is used to select a default movie file. The process then opens all of the movie files, buffers the files into RAM memory and plays all of the files simultaneously with a synchronized start in step 609. All of the movie files are playing in the background throughout the process. In step 611 the default movie is conducted to the display screen.

In step 613 a camera image is obtained again, and the current position of the user is determined and set as CURRENT subject position data in step 615. This CURRENT subject position data is compared to the PREVIOUS subject position data and motion parameters are calculated in step 617. In step 619 it is determined if the user has moved. If the user has moved, the process proceeds to step 621 where a different movie is selected based on the current position of the user. For example, without limitation, as the user moves horizontally, the program sets data concerning the user's motion with respect to the system and executes decisions as to which processing movie file should be displayed on the display canvas. This is similar to the effect in an application displaying a still image, whereas instead of selecting a different image file to display, the program is selecting a different processing digital movie to be displayed. In step 623 the selected movie is conducted to the display screen. At this point or if the user has not moved in step 619, the PREVIOUS subject position data is set to the CURRENT subject position data in step 625. Then, in step 627, it is determined if there has been any input to interrupt the process. If not, the process returns to step 613. If so, the process ends. The process is repeated continuously until interrupted. For best performance, the movies playing in this case must be exactly in synch, which means at a given moment, all of the processing movies are at the same part of the movie, and the only thing that changes is the camera angle used in each file. An alternate embodiment may be implemented that does not run in a loop. In this embodiment a video is chosen based on the location of the user at the time of execution, and this video does not change until the program is executed again, for example, without limitation, by a prompt from the user.

In another non-limiting example of an application that may use a preferred embodiment of the present invention, the application displays a 3D television broadcast. For example, without limitation, a user is watching a televised boxing match, and as the user moves to the right with respect to the system, the televised scene rotates displaying the boxing ring from its right side. As the user gradually moves to the center of the room with respect to the television, the televised scene gradually rotates to left showing the boxing ring from its front side. As the user continues moving to the left in relation to the television, the televised scene continue to rotate showing the boxing ring from its left side. In this use case, the image source is a tuner that receives broadcasted channels. For example, without limitation, the transmission can be from a regular cable or satellite provider. The computer in this scenario is the signal receiver or tuner required to access the transmission, or a computer with a tuner.

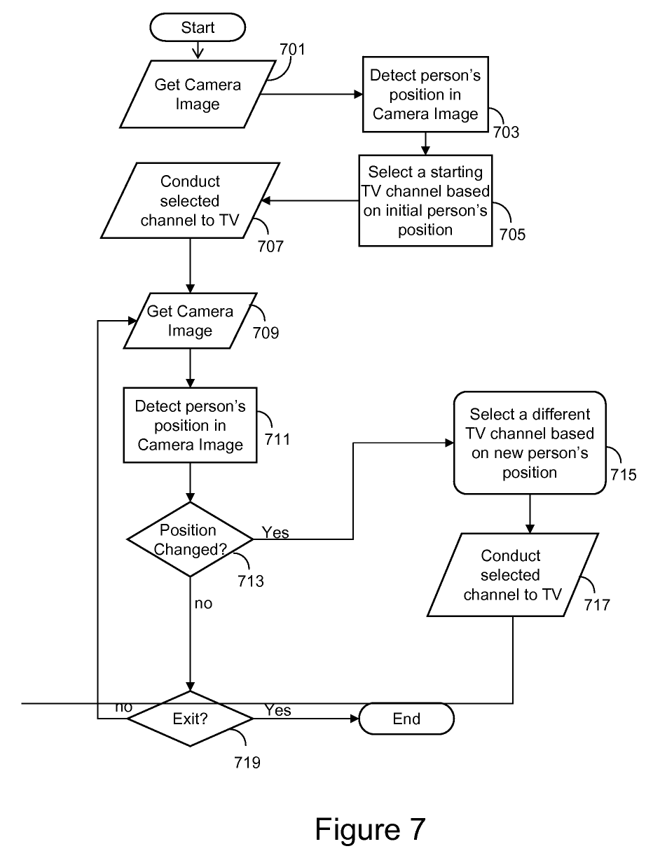

FIG. 7 is a flowchart illustrating an exemplary process for using a method of displaying images based on the location of a user to display a 3D television broadcast, in accordance with an embodiment of the present invention. In the present embodiment, the television broadcast is transmitted over a plurality of channels, for example, without limitation, ten different channels televising the same event at the same time with each channel transmitting the scene recorded from a different angle. For example, without limitation, in the boxing match scenario, there may be ten cameras placed around the boxing ring in an arch that surrounds the southwest, south and southeast sides of the boxing ring.

The tuner, or receiver, has access to receive transmissions from the multiple different channels, and the tuner, or receiver, which is the computer in this example has a camera mounted near the television screen operable to capture the user position. In step 701 the camera obtains an image of the user, and the position of the user is determined from this image in step 703. In step 705, this position is used to choose a starting television channel, and in step 707 this television channel is conducted to the television and displayed. Another camera image of the user is obtained in step 709, and the position of the user is determined again in step 711. In step 713 it is determined if the position of the user has changed. If so, the process proceeds to step 715. As the user moves from left to right, the program detects the user's position and movements and produces data pertaining to the user's motion with respect to the camera and display screen. In turn, the process uses this data as parameter value for automatically selecting which channel image should be conducted to the television display in step 715. In step 717, this channel is conducted to the television display. At this point or if the user has not moved in step 713, it is determined if there is any input to interrupt the process in step 719. If not, the process returns to step 709. If so, the process ends.

In a non-limiting example, a sports network is transmitting a boxing fight from different angles on channels 150 through 159. At first, an index of channels 150 through 159 is created. Then, the program automatically selects a channel to be displayed on the display screen based on user position, and this repeats over and over in a loop. An alternate embodiment may be implemented that does not run in a loop. In this embodiment a television channel is chosen based on the location of the user at the time of execution, and this channel does not change until the program is executed again, for example, without limitation, by a prompt from the user.

Another application for preferred embodiments of the present invention is to employ the method in image-generating software, such as, but not limited to, a video game. In this application, the program acquires the parameters pertaining to the user location and uses these parameters in an algorithm for generating images instead of selecting existing local images. For example, without limitation, a program may generate an image of a tennis-court. If the user is a little to the left of the center of the screen, the program generates and renders the tennis-court as seen from “a little to the left”, if the user is centered, the program generates and renders the tennis-court as seen from the center, and the same for user locations to the right, down, or up from the center of the screen's viewable area. In other words, an image-generating software, prior to generating images, acquires the user location and uses the user location as a parameter for generating images in a certain way. The present embodiment uses the angle of the user's position with relation to the screen to generate the image, and this location is not used to process an image of the user, but instead it is used to generate a whole new image, only using the user position as parameter. A non-limiting example of where this application may be used is a GPS navigator. Today's GPS navigator devices generate map images on the fly using the device's current position and direction. Using an embodiment of the present invention, the GPS navigator device also uses the user's viewing angle as a parameter in order to generate the map image with a little twist. This variation, as in other preferred embodiments, requires the device to be equipped with a camera or similar device in order to capture the user location to determine the viewing angle.

Another application for preferred embodiments of the present invention is to employ this method to digitally process images based on a user's movements. Image processing software solutions on the market today offer many effects to digitally alter images, such as, but not limited to, zooming the image, panning, stretching, rotating, changing the pixel orientation, and many other effects. These existing software solutions enable a user to manipulate digital images by using a mouse, joystick, or arrow keys. The same existing effects can be used to manipulate images in preferred embodiments, but instead of using a mouse or a joystick, these embodiments can execute these effects based on user movements by using the user motion parameters instead of mouse or joystick parameters in order to apply image effects. An exemplary method for accomplishing this is as follows. First, the program or user opens an image. Then, the program acquires the location of the user and applies one or more image effects to the image file using the user location parameter to drive that effect. Then, the steps of acquiring the user location and applying effects to the image are repeated until the program is exited.

Preferred embodiments of the present invention are not limited to a particular method for obtaining or estimating the user position. The prior art employed to indicate the user position is irrelevant as long as the chosen method can return numeric parameters that can satisfy the program. Exemplary methods that may be used include, without limitation, methods that use an array of infrared sensors, methods that use a digital camera to detect the user's face or eyes, methods that may use heat cameras, methods the require an apparatus placed with the encumbered user, etc. Furthermore, the user position can be returned in various ways including, but not limited to, coordinates (i.e., how far to the left, right, up, down, far, near), in angles (i.e., degrees to the right, left, up, down), in “movements”, etc. A non-limiting example of how the user position can be returned in “movements” is a follows. The user moves x degrees or x centimeters to the right, and in this case, the main method calculates, based on the previous user location, what the new location of the user is. In preferred embodiments, the user's motion is recorded with relation to the camera. This means that the user may be moving while the camera is motionless, or the user may be motionless in a room while the camera moves. A non-limiting example of this scenario is the user moving a handheld system in his or her hands.

Likewise, there is no limitation on the type of image or format of the image to be displayed using preferred embodiments of the present invention. Also, the images to be allocated in memory and indexed may come from multiple files or from a single file. Those skilled in the art, in light of the present teachings, will readily recognize that there exists prior art for storing multiple still images within the same file, and in some applications, these images are tiled for browsing based on coordinates, for example, without limitation, parts of a map. A collection of separate image files or a single file containing multiple image shots can be used. In some embodiments a single image can be used, as it is not necessary to have multiple images to begin this method. As explained earlier in reference to FIG. 5, a single image can be manipulated multiple times and stored as many different resulting variations of the same parent image before the loop begins. Furthermore, preferred embodiments are not limited to using still images, and these embodiments may be used to display video as well. For example, without limitation, the image source may be digital video files. The method for video files is applied slightly differently than for still images, wherein the method opens each digital video file and stores (i.e., buffers) each video in memory. Then the method plays all of the video files simultaneously. Based on the user location parameter, the method automatically chooses one specific video to be displayed on the display screen, while all other videos continue to play in the background unseen.

In addition, preferred embodiments of the present invention are not limited to a specific type of data structure for indexing information. Array of objects is described in the foregoing embodiments; however, alternate types of data structures may be used such as, but not limited to, link lists, vectors, array lists, database tables, trees, etc. Furthermore, preferred embodiments are not required to use single data structures. An application applying a method according to a preferred embodiment may use multiple arrays or multiple data structures of other types, especially if dealing with multiple dimensions of user movement, for example, without limitation, an application that deals with horizontal, vertical, and depth information about the user location.

Image sources used in preferred embodiments are not limited to local content. Images may be from remote sources such as, but not limited to, content on the Internet or content broadcasted by television. For example, without limitation, a boxing fight may be recorded with multiple cameras and transmitted over an array of ten different television channels. A receiver or tuner capable of executing a method according to preferred embodiments may store an index of channels to be used, then in a loop obtain the user current location parameter and use this location to select from the index a channel to be displayed. If the user moves, the user location parameter value changes, and the method may decide on a different channel to be displayed. The effect is that as the user moves around the television display screen the user sees images from a different channel transmitting the event from a different angle. In another non-limiting example, the image source may be remote images or video files from a remote system on the Internet. The same way Internet browsers and plug-ins download and buffer images and videos, they may download and buffer multiple images and videos, and display an image based on user location. These multiple images or videos do not need to be from multiple downloaded files, as a single downloaded file my contain multiple still images or multiple video content.

Some embodiments may be implemented with additional tasks added on depending on the application. For example, without limitation, the application of choosing an image to be displayed based on user location is described in the foregoing embodiments. Within the same loop, an application may, in addition, play a sound along with displaying the chosen image based on user position. Another example of an additional task is a wait period inside the loop that saves system resources, for example, without limitation, a wait period of 0.5 seconds before acquiring user position. Those skilled in the art, in light of the present teachings, will readily recognize that a multiplicity of additional tasks may be added to embodiments of the present invention such as, but not limited to, playing a sound, waiting a period, appending data to a log or output file, checking user input that may have an intentional effect on the selection of image to be displayed, updating the value of program variables or system variables, checking program variables or system variables that may have an effect on the method execution, checking input from another source such as a keyboard, mouse or joystick to be considered along with the user position parameter for calculating image to be displayed, and replacing images in the image index, switching to a different index of images, switching to different image source, etc.

Preferred embodiments of the present invention, as they invoke another method for obtaining user location, may be implemented as a single computer program or as multiple computer programs that interact with each other.

More advanced applications of preferred embodiments may offer a calibration mechanism. This may be implemented as a run-once part of step 203 in FIG. 2 and step 513 in FIG. 5. In these embodiments, the calibration mechanism may be executed when an application is first run and is not executed in any looping action. In embodiments shown in FIGS. 6 and 7, the calibration mechanism may be integrated as part of step 603 or step 701. In other embodiments, the calibration mechanism may be a separate setup option. As an integrated mechanism or as a setup option, an application can prompt the user to go through calibration exercises such as, but not limited to, moving 45 degrees to the right of the center of the display screen then 45 degrees to the left of the center of the display screen. At each position the user's position is captured and stored. By doing so, the program can store, for example, but not limited to, ratio variables, position parameters, etc. that can be used to calculate or compensate the user location. In these embodiments, the user position parameters captured during system calibration are stored as accessible variables that can be used to calculate more effectively what image should be displayed. This allows for consistent results, as the parameter from capturing user location may vary from system to system. Each application may use its own calculation for handing the user position parameter and deciding which index value (i.e., image) to retrieve. In some embodiments, calculations or conditions to decide what image to display may not be necessary. For example, without limitation, a program may be implemented so that the parameter from the user location is the identification of the image with nothing else to decide. In this example, the location parameter returned is a numeric value 35, and the program displays image[35], meaning the parameter is the index number. Preferred embodiments are not limited to a specific calculation for converting user location parameter into an index value. This calculation is determined by the developer or the application using the method of displaying an image based on user position.

In an alternate embodiment of the present invention, if the user does not move after the last position is acquired, the method does not need to choose another image. For example, without limitation, if the user position is the same as the user's last position, the method continues to display the same image and acquires the user position again. If the new user position is different from the previous position, the user has moved, and the method chooses a new image to display.

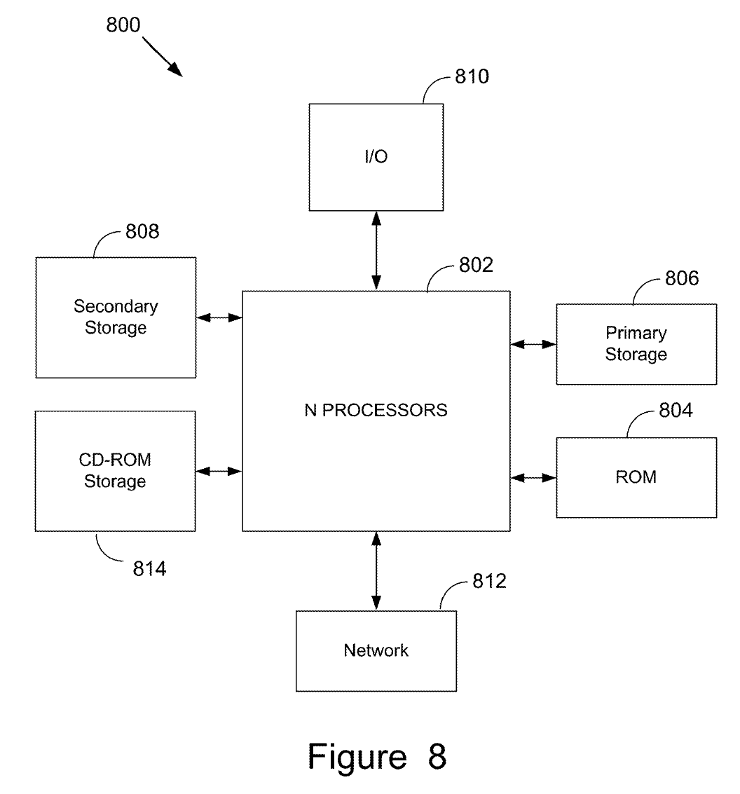

FIG. 8 illustrates a typical computer system that, when appropriately configured or designed, can serve as a computer system in which the invention may be embodied. The computer system 800 includes any number of processors 802 (also referred to as central processing units, or CPUs) that are coupled to storage devices including primary storage 806 (typically a random access memory, or RAM), primary storage 804 (typically a read only memory, or ROM). CPU 802 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 804 acts to transfer data and instructions uni-directionally to the CPU and primary storage 806 is used typically to transfer data and instructions in a bi-directional manner. Both of these primary storage devices may include any suitable computer-readable media such as those described above. A mass storage device 808 may also be coupled bi-directionally to CPU 802 and provides additional data storage capacity and may include any of the computer-readable media described above. Mass storage device 808 may be used to store programs, data and the like and is typically a secondary storage medium such as a hard disk. It will be appreciated that the information retained within the mass storage device 808, may, in appropriate cases, be incorporated in standard fashion as part of primary storage 806 as virtual memory. A specific mass storage device such as a CD-ROM 814 may also pass data uni-directionally to the CPU.

CPU 802 may also be coupled to an interface 810 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 802 optionally may be coupled to an external device such as a database or a computer or telecommunications or internet network using an external connection as shown generally at 812, which may be implemented as a hardwired or wireless communications link using suitable conventional technologies. With such a connection, it is contemplated that the CPU might receive information from the network, or might output information to the network in the course of performing the method steps described in the teachings of the present invention.

```
TABLE 1
// SAMPLE CODE 1
// Example of automatically selecting image to display based on user position
#include “filenames.inc”
#include “bitmap.inc”
#include “camera.inc”
// Function get_face_hrz_pos(void)
//  gets image from camera, detects user face, and return a value
//  returns a number from 0-99:
//  0 if face is all the way to the left. 0 if centered. 99 if all the way to the right
int get_face_hrz_pos(void);
// Procedure display(Bitmap)
//  refreshes display area with the image
void display(Bitmap);
int main( )
{
      int face_hrz_position;
      int last_fc_hrz_position;
      // get names of the image files to display
      ImageFiles my_files;
      my_files.initialize( ); //get name, directory or URL of image files
      // declare array of images
      Bitmap* image_list;
      image_list = new Bitmap[my_files.get_file_count( )];
      // pre-load images into array of objects
      for(int i = 0; i < files.file_count; i++){
            image_list[i] = (Bitmap) Bitmap.FromFile(files.get_file_name(i));
      }
      // DISPLAY STARTING IMAGE
      last_fc_hrz_position = get_face_hrz_pos( );
      display(image_list[last_fc_hrz_position]);
      // RUN LOOP
      while(!interrupt( )){
            face_hrz_position = get_face_hrz_pos( );
            if (face_hrz_position != last_fc_hrz_position){
                  display(image_list[face_hrz_position]);
                  last_fc_hrz_position = face_hrz_position;
            }
      }
      return 0;
}
int get_face_hrz_pos( ){
      Bitmap camera_shot = (Bitmap) camera.get_image( );
      return face_hrz_pct(camera_shot); --- prior art invoked here to get user position
}
```

```
TABLE 2
// SAMPLE CODE 2
// Example of pre-allocate images already processed,
// for automatically selecting image to display based on user position
#include “bitmap.inc”
#include “camera.inc”
#include “filters.inc”
// Function get_face_hrz_pos(void)
// gets image from camera, detects user face, and return a value
// returns a number from 0-99:
// 0 if face is all the way to the left. 0 if centered. 99 if all the way to the right
int get_face_hrz_pos(void);
// Procedure display(Bitmap)
// refreshes display canvas with the image
void display(Bitmap);
// Function for processing an image with effects and returning modified image
// effects applied will vary based on numeric parameter value provided
Bitmap apply filters(Bitmap, int);
int main( )
{
      int face_hrz_position;
      int last_fc_hrz_position;
      // open single image file
      Bitmap my image = (Bitmap) Bitmap.FromFile(“c:/test.bmp”);
      // declare array of 100 images
      Bitmap* image_list;
      image_list = new Bitmap[100];
      // Process effects on original image 100 times using incremental parameters
      // pre-load resulting images into array of objects, ALREADY PROCESSED
      for(int i = 0; i < 100; i++){
            image_list[i] = (Bitmap) apply_filters(my_image, i );
      }
      //now we have in array 100 manipulated (probably distinct) images
      // DISPLAY STARTING IMAGE
      last_fc_hrz_position = get_face_hrz_pos( );
      display(image_list[last_fc_hrz_position]);
      // RUN LOOP
      while(!interrupt( )){
            face_hrz_position = get_face_hrz_pos( );
            if (face_hrz_position != last_fc_hrz_position){
                  display(image_list[face_hrz_position]);
                  last_fc_hrz_position = face_hrz_position;
            }
      }
      return 0;
}
int get_face_hrz_pos( ){
      Bitmap camera_shot = (Bitmap) camera.get_image( );
      return face_hrz_pct(camera_shot);
}
```

```
TABLE 2
// SAMPLE CODE 3
// Example of pre-allocate images already processed,
// for automatically selecting image to display based on user position
// Same as SAMPLE CODE 3 but images arranged in 2 dimensions
#include “bitmap.inc”
#include “camera.inc”
#include “filters.inc”
// Procedure get_face_pos(int horizontal, int vertical)
// gets image from camera, detects user face, and return 2 value
// returns a number from 0-99 for the horizontal position of the person
// returns a number from 0-99 for the vertical position of the person
void get_face_hrz_pos(&int, &int);
// Procedure display(Bitmap)
// refreshes display area with the image
void display(Bitmap);
// Procedure for processing an image and returning modified image
Bitmap apply_filters(Bitmap, int, int);
int main( )
{
      int horizontal, vertical, last_horiz, last_vertic;
      Bitmap my_image = (Bitmap) Bitmap.FromFile(“c:/test.bmp”);
      // declare array of images
      Bitmap* image_list;
      image_list = new Bitmap[10][10];
      // pre-load images into array of objects, to store them ALREADY PROCESSED
      for(int h = 0; h < 10; h++){
            for(int v = 0; v < 10; v++){
                  image_list[h][v] = (Bitmap) apply_filters(my_image, h, v);
            }
      }
      // DISPLAY STARTING IMAGE
      get_face_pos(&last_horiz, &last_vertic);
      display(image_list[last_horiz][last_vertic]);
      // RUN MOTION RESPONSIVE DISPLAY LOOP
      while(!interrupt( )){
            get_face_pos(&horizontal, &vertical);
            if (horizontal != last_horiz || vertical != last_vertic){
                  display(image_list[horizontal][vertical]);
                  last_horiz = horizontal;
                  last_vertic = vertical;
            }
      }
      return 0;
}
int get_face_hrz_pos( ){
      Bitmap camera_shot = (Bitmap) camera.get_image( );
      return face_hrz_pct(camera_shot);
}
```

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC § 112 (6) it is intended that the corresponding means for and/or steps for carrying out the claimed function also include those embodiments, and equivalents, as contemplated above that implement at least some novel aspects and objects of the present invention in the jurisdiction of the USA. For example, the image source element (such as, without limitation, files on a remote host) may be performed and/or located outside of the jurisdiction of the USA while the remaining method steps and/or system components of the forgoing embodiments (e.g., without limitation, the user, camera, computer and computer code) are typically required or optimal to be located/performed in the US for practical considerations.

Having fully described at least one embodiment of the present invention, other equivalent or alternative methods of indexing images and automatically choosing an image to be displayed based on the location of a user according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for displaying images according to user position, the method comprising the steps of:
receiving a plurality of source images;
indexing said plurality of source images;
capturing a current user's position relative to a display suitable for presenting said plurality of source images;
choosing a one of said plurality of source images by relating at least one parameter of said current user's position with indices of said indexed plurality of source images; and
displaying said one of said plurality of source images on said display.

2. The method as recited in claim 1, further comprising the step of repeating the steps of capturing, choosing and displaying until the method is terminated.

3. The method as recited in claim 1, further comprising the step of repeating, until the method is terminated, the step of capturing and repeating the steps of choosing and displaying if said current user's position is different from a previous captured user's position.

4. The method as recited in claim 1, further comprising the step of repeating the steps of capturing, choosing and displaying upon command from the user.

5. The method as recited in claim #, wherein said plurality of source images comprises a plurality of digital still images.

6. The method as recited in claim 1, wherein said plurality of source images comprises at least one still image and a plurality of still images derived from altering said at least one still image.

7. The method as recited in claim 1, wherein said plurality of source images comprises a plurality of motion videos and the method further comprises the step of starting playback of said plurality of source images at substantially the same time.

8. The method as recited in claim 7, wherein said plurality of motion videos comprises a plurality of digital videos being received from a remote computer.

9. The method as recited in claim 1, wherein said plurality of source images comprises a plurality of motion videos being received on a plurality of television channels.

10. The method as recited in claim 1, further comprising the steps of prompting a user to assume a plurality of determined calibration positions relative to a display; capturing a position of the user at each of said plurality of determined calibration positions; and storing said captured positions for relating further captured positions to said indexed plurality of source images.

11. A method for displaying images according to user position, the method comprising:
steps for receiving a plurality of source images;
steps for indexing said plurality of source images;
steps for capturing a current user's position;
steps for choosing a one of said plurality of source images; and
steps for displaying said one of said plurality of source images.

12. The method as recited in claim 11, further comprising steps for repeating the steps for capturing, choosing and displaying.

13. The method as recited in claim 11, further comprising steps for calibrating a user's positions.

14. A computer program product for displaying images according to user position, the computer program product comprising:
computer code for receiving a plurality of source images;
computer code for indexing said plurality of source images;
computer code for capturing a current user's position relative to a display suitable for presenting said plurality of source images;
computer code for choosing a one of said plurality of source images by relating at least one parameter of said current user's position with indices of said indexed plurality of source images;
computer code for displaying said one of said plurality of source images on said display; and
a computer-readable medium storing said computer code.

15. The computer program product as recited in claim 14, further comprising computer code for repeating said capturing, choosing and displaying.

16. The computer program product as recited in claim 14, further comprising computer code repeating said capturing and repeating said choosing and displaying if said current user's position is different from a previous captured user's position.

17. The computer program product as recited in claim 14, further comprising computer code for repeating said capturing, choosing and displaying upon command from the user.

18. The computer program product as recited in claim 14, wherein said plurality of source images comprises a plurality of digital still images.

19. The computer program product as recited in claim 14, wherein said plurality of source images comprises at least one still image and a plurality of still images derived from altering said at least one still image.

20. The computer program product as recited in claim 14, wherein said plurality of source images comprises a plurality of motion videos and the computer program product further comprises computer code for starting playback of said plurality of source images at substantially the same time.

21. The computer program product as recited in claim 20, wherein said plurality of motion videos comprises a plurality of digital videos being received from a remote computer.

22. The computer program product as recited in claim 14, wherein said plurality of source images comprises a plurality of motion videos being received on a plurality of television channels.

23. The computer program product as recited in claim 14, further comprising computer code for prompting a user to assume a plurality of determined calibration positions relative to a display; capturing a position of the user at each of said plurality of determined calibration positions; and storing said captured positions for relating further captured positions to said indexed plurality of source images.

24. A system for displaying images according to user position, the system comprising:
means for receiving a plurality of source images;
means for indexing said plurality of source images;
means for capturing a current user's position;
means for choosing a one of said plurality of source images; and
means for displaying said one of said plurality of source images.

25. The system as recited in claim 24, further comprising means for repeating the steps for capturing, choosing and displaying.

26. The system as recited in claim 24, further comprising means for calibrating a user's positions.
